(19) United States
(12) Patent Application Publication
(10) Pub. No.: US 2026/0119035 A1
(43) Pub. Date: Apr. 30, 2026

(54) SHARED PARITY STORAGE

(71) Applicant: Micron Technology, Inc., Boise, ID (US)

(72) Inventors: Xiangang Luo, Fremont, CA (US); Ting Luo, Santa Clara, CA (US); Jameer Mulani, Bangalore (IN); Rakeshkumar Dayabhai Vaghasiya, Hyderabad (IN); Yuqi Zhu, Milpitas, CA (US)

(21) Appl. No.: 19/003,809

(22) Filed: Dec. 27, 2024

Related U.S. Application Data
(60) Provisional application No. 63/617,037, filed on Jan. 2, 2024.

(51) Int. Cl. G06F 3/06

(52) U.S. Cl. CPC G06F 3/0608; G06F 3/0659; G06F 3/0689

(57) ABSTRACT

Methods, systems, and devices for shared parity storage are described. A memory system may include a shared parity storage configured to store parity information from multiple logical partitions of the memory system. For example, parity information associated with a first page of a first logical partition may be combined with parity information associated with a second page of a second logical partition, and stored to the shared parity storage. The memory system may support replacing combined parity information by deconstructing the combined parity information and reconstructing the combined parity information with parity information associated with another page of the first or second logical partition. The memory system may support performing a maintenance operation on the first logical partition by deconstructing the combined parity information, folding data from the first logical partition, and reconstructing the combined parity information without parity information associated with the invalid data of the first logical partition.

### CROSS REFERENCE

The present Application for Patent claims priority to U.S. patent application Ser. No. 63/617,037 by Luo et al., entitled “SHARED PARITY STORAGE”, filed Jan. 2, 2024, which is assigned to the assignee hereof, and which is expressly incorporated by reference in its entirety herein.

### TECHNICAL FIELD

The following relates to one or more systems for memory, including for shared parity storage.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports shared parity storage in accordance with examples as disclosed herein.

FIG. 2 shows an example of a block diagram that supports shared parity storage in accordance with examples as disclosed herein.

FIG. 3 shows an example of a process flow that supports shared parity storage in accordance with examples as disclosed herein.

FIG. 4 shows a block diagram of a memory system that supports shared parity storage in accordance with examples as disclosed herein.

FIG. 5 shows a flowchart illustrating a method or methods that support shared parity storage in accordance with examples as disclosed herein.

### DETAILED DESCRIPTION

A memory system may include one or more non-volatile memory arrays (e.g., NAND memory arrays) which may be partitioned (e.g., logically separated) into a quantity of logical partitions (e.g., zones, cursors, superblocks). For example, each logical partition may include one or more pages from a quantity of planes of the non-volatile memory arrays, where each page is configured to store data written to the respective non-volatile memory array. In some cases, writing data to the pages of the one or more non-volatile memory arrays may include writing parity information (e.g., parity bits) associated with the data to a volatile memory of the memory system (e.g., SRAM of a memory system controller, a buffer).

For example, the memory system may include one or more redundant arrays of independent NAND (RAIN) storage areas for storing the parity information (e.g., for use in data recovery), such that the memory system may implement a respective RAIN storage area for storing parity information (e.g., RAIN parity) from each logical partition. However, RAIN storage areas may be relatively expensive and may consume a relatively large amount of space within a memory system. Thus, implementing a respective RAIN storage area for each logical partition may be undesirable. A memory system configured to implement a single RAIN storage area for multiple logical partitions may be desirable.

A memory system configured to implement a RAIN storage area for multiple logical partitions is described herein. In accordance with examples as disclosed herein, the memory system may include a single (e.g., one) RAIN storage area configured to store parity information associated with a quantity of logical partitions. The memory system may be configured to perform one or more logical operations to combine parity information from the logical partitions and store the combined parity information in the RAIN storage area. For example, the memory system may perform an operation, such as an exclusive-or (XOR) operation, on parity information associated with data of a first logical partition and parity information associated with data of a second logical partition. The resulting parity bits (e.g., the XOR'ed parity bits) may include a same quantity of bits as the parity bits associated with the data of the first logical partition or the parity bits associated with the data of the second logical partition. That is, the parity information may be combined without increasing the quantity of bits needed to store to the RAIN storage area. Thus, the memory system may implement a single RAIN storage area for multiple logical partitions, thereby reducing or otherwise mitigating the cost and space associated with implementing multiple RAIN storage areas in other different examples.

In addition to applicability in memory systems as described herein, techniques for shared parity storage may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing space for storage of some information, decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by enabling efficient storage of parity information without increasing memory cost or size, which may improve memory density, performance, and capacity, among other benefits.

In addition to applicability in memory systems as described herein, techniques for shared parity storage may be generally implemented to support edge computing applications. Edge computing is a distributed computing paradigm that brings computation and data storage closer to the sources of data than traditional cloud services. As the use of edge computing to provide computing, storage, and networking services at locations that are geographically closer to end users increases, many devices and systems may benefit from improved processing, performance, and storage management at edge devices. For example, increasing memory density, capacity, and processing power of edge devices may decrease a reliance on the devices to remote computing or devices, which may otherwise increase latency of operations performed at the devices. Implementing the techniques described herein may support edge computing techniques by enabling efficient storage of parity information with decreased memory usage, which may improve memory density and capacity in relevant devices, among other benefits.

Features of the disclosure are illustrated and described in the context of systems, devices, and circuits. Features of the disclosure are further illustrated and described in the context of block diagrams, a process flow, and a flowchart.

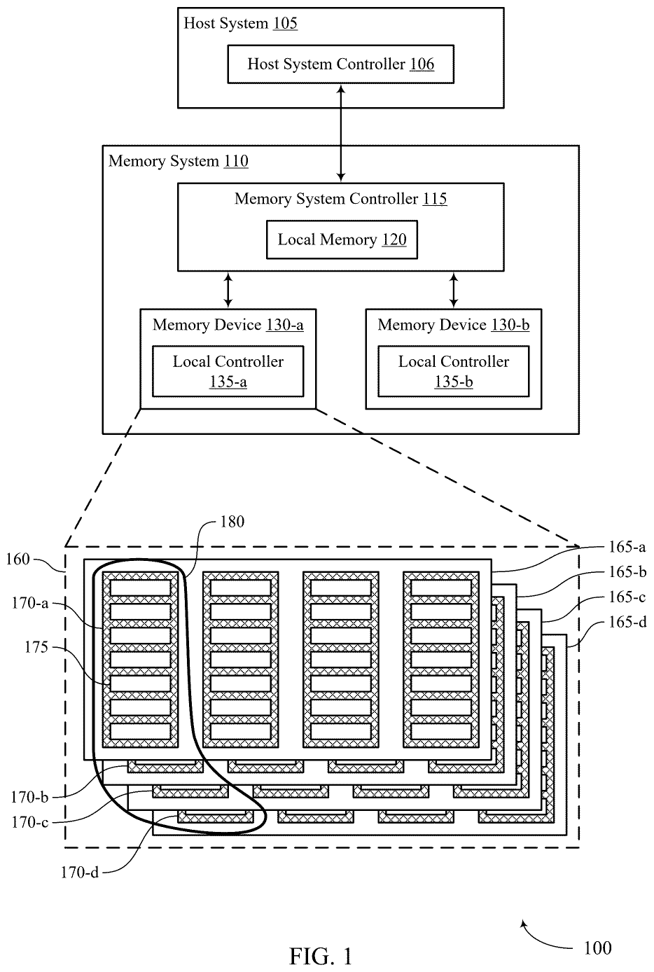

FIG. 1 shows an example of a system 100 that supports shared parity storage in accordance with examples as disclosed herein. The system 100 includes a host system 105 coupled with a memory system 110. The system 100 may be included in a computing device such as a desktop computer, a laptop computer, a network server, a mobile device, a vehicle (e.g., train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

The system 100 may include any quantity of non-transitory computer readable media that support shared parity storage. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In accordance with examples as disclosed herein, the memory system 110 may include a single (e.g., one) RAIN storage area configured to store parity information associated with data from a quantity of (e.g., multiple) logical partitions (e.g., zones, cursors, superblocks) of one or more non-volatile memory arrays (e.g., NAND memory arrays) of the memory system 110. The memory system 110 may be configured to perform one or more logical operations (e.g., XOR operations) to combine parity information associated with data from the logical partitions and store the combined parity information in the RAIN storage area.

For example, the memory system 110 may perform an XOR operation on parity information associated with data of a first logical partition and parity information associated with data of a second logical partition. The resulting parity bits (e.g., the XOR'ed parity bits) may include a same quantity of bits as the parity bits associated with the data of the first logical partition or the parity bits associated with the data of the second logical partition. That is, the parity information may be combined without increasing the quantity of bits to store to the RAIN storage area. Thus, the memory system 110 may implement a single RAIN storage area for multiple logical partitions, thereby reducing or otherwise mitigating the cost or space associated with implementing multiple RAIN storage areas.

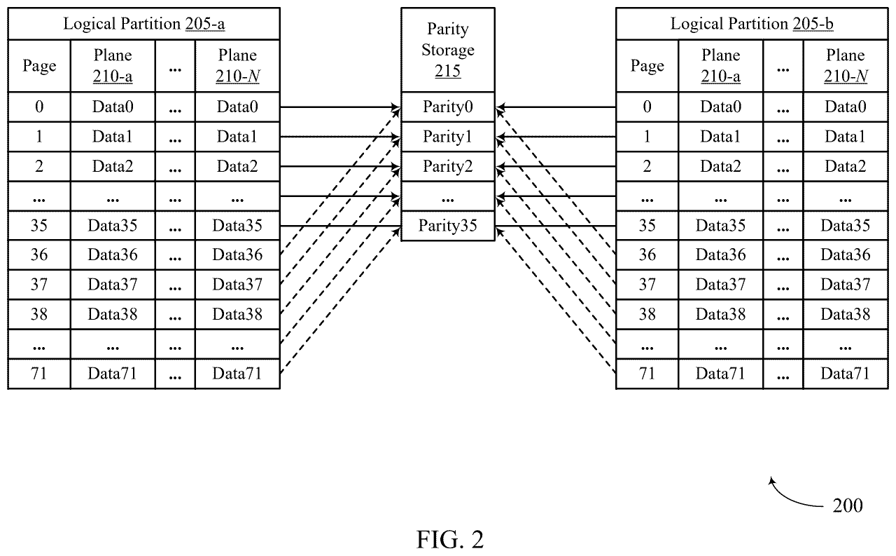

FIG. 2 shows an example of a block diagram 200 that supports shared parity storage in accordance with examples as disclosed herein. The block diagram 200 may illustrate aspects or operations of a system, which may be an example of a system 100, as described with reference to FIG. 1. For example, the block diagram 200 may illustrate operations of a memory system, which may be an example of a memory system 110, as described with reference to FIG. 1. The block diagram 200 illustrates storing parity information to a parity storage 215 based on combining parity information from logical partitions 205 of the memory system 110.

The memory system 110 may include one or more memory devices 130 (e.g., each of which including one or more memory dies 160) as described with reference to FIG. 1. The one or more memory devices 130 may be non-volatile memory devices, such that the one or more memory devices 130 may include one or more non-volatile memory arrays (e.g., NAND memory arrays). The one or more non-volatile memory arrays may be partitioned (e.g., logically separated, divided, or grouped) into a quantity of logical partitions 205, including at least logical partition 205-a and logical partition 205-b. The logical partitions 205 may be examples of zones, cursors, or superblocks, such that each logical partition 205 may include a quantity of logical block addresses which may be logically contiguous.

Each logical partition 205 may include a quantity of planes 210 (e.g., plane 210-a to plane 210-N, where N may correspond to any positive integer) spanning the respective logical partition 205. In some examples, the planes 210 may be examples of planes 165, as described with reference to FIG. 1. Each plane 210 may include a quantity of pages, where each page (e.g., page 0) of a plane 210 (e.g., plane 210-a) may correspond to a page (e.g., page 0) of another respective plane 210 (e.g., plane 210-N) of the respective logical partition 205. In some examples, the pages may be examples of pages 175, as described with reference to FIG. 1. That is, each logical partition 205 may include N planes 210 each including a quantity of pages such that, for example, page 0 spans each of the N planes 210. In some instances, each page may be described relative to a logical partition 205 and may be understood as referring to each corresponding page of the planes 210 of the respective logical partition 205.

Each page may be configured to store data for the memory system 110, such that data written to the memory system 110 may be stored in the pages of the logical partitions 205. In some cases, each page may be associated with a quantity of memory cells, which may be single-level cells (SLCs), multi-level cells (MLCs), triple-level cells (TLCs), or quad-level cells (QLCs), among other possibilities.

The memory system 110 may also include a parity storage 215 configured to store parity information associated with data of the memory system 110. In some cases, the parity storage 215 may be or may be referred to as a RAIN storage area, such that the memory system 110 may be configured to support RAIN parity (e.g., the parity storage 215 may be configured to store RAIN parity). The parity information may include one or more parity bits associated with data recovery, error detection, or error correction. For example, the parity information may include one or more parity bits that may be utilized to recover data in the event of an error (e.g., data corruption, data errors).

In some examples, the parity storage 215 may similarly include a quantity of pages, where each page may be configured to store one or more bits of parity information. For example, the parity storage 215 may include 36 pages, where each page may store 16 KB of parity information (e.g., the parity storage 215 may store 576 KB of parity information). In some implementations, each page of the parity storage 215 may store the parity information associated with data stored in a corresponding page of the logical partitions 205. For example, page 0 of the parity storage 215 may store parity bits associated with data bits (e.g., DATA0) in page 0 of the logical partitions 205 (e.g., the logical partition 205-a, the logical partition 205-b).

In some cases, a conventional memory system may implement a parity storage for each logical partition of the memory system. For example, the memory system may include 7 logical partitions, and thereby implement 7 parity storages. Each parity storage may be associated with storing parity information associated with data from the respective logical partition. However, implementing parity storages for each logical partition may be associated with a relatively high allocation of volatile memory (e.g., SRAM, buffer). For example, if each parity storage includes 36 pages and each page is allocated 16 KB of volatile memory for storing parity information, implementing 7 parity storages (e.g., for 7 logical partitions) may require 4,032 KB of volatile memory. Implementing volatile memory may be relatively expensive to implement, thus implementing parity storages (e.g., 4,032 KB of volatile memory) for each logical partition may be relatively expensive.

In accordance with examples as described herein, implementing the parity storage 215 for a quantity of logical partitions 205 (e.g., for multiple logical partitions 205) may require less volatile memory, and therefore may be less expensive compared to conventional memory systems. That is, the parity storage 215 may include 36 pages where each page is allocated 16 KB of volatile memory for storing parity information, thus the memory system 110 may include 576 KB of volatile memory for parity storage 215 (e.g., rather than 4,032 KB of volatile memory, as in previous implementations). Implementing relatively less volatile memory for parity storage 215 may decrease expenses otherwise associated with implementing RAIN parity, among other advantages.

The memory system 110 may implement the parity storage 215 to store the parity information from each logical partition 205. That is, the parity storage 215 may be configured to store the parity information associated with data from at least the logical partition 205-a and the logical partition 205-b. The memory system 110 may be configured to perform one or more logical operations (e.g., XOR operations) to combine the parity information from logical partition 205-a with the parity information from the logical partition 205-b. The memory system 110 may be configured to store the combined parity information in the parity storage 215.

For example, the memory system 110 may write data (e.g., Data0) to page 0 of the logical partition 205-a (e.g., based on a write command), and may write data (e.g., Data0) to page 0 of the logical partition 205-b (e.g., based on a write command). Although Data0 written to page 0 of the logical partition 205-a shares similar nomenclature to Data0 written to page 0 of the logical partition 205-b, it should be understood that the data bits of Data0 written to page 0 of the logical partition 205-a may be different than the data bits of Data0 written to page 0 of the logical partition 205-a. Likewise, although Data 0 written to page 0 of the plane 210-a shares similar nomenclature to Data0 written to page 0 of the plane 210-N, it should be understood that the data bits of Data0 written to page 0 of the plane 210-a may be different than the data bits of Data0 written to page 0 of the plane 210-N.

In some cases, the memory system 110 may receive parity information (e.g., one or more parity bits) associated with page 0 of the logical partition 205-a and additional parity information (e.g., one or more parity bits) associated with page 0 of the logical partition 205-b. In other cases, the memory system 110 may generate both the parity information associated with page 0 of the logical partition 205-a and the parity information associated with page 0 of the logical partition 205-b. The memory system 110 may perform one or more XOR operations using the parity information associated with page 0 of the logical partition 205-a and the additional parity information associated with page 0 of the logical partition 205-b.

In some examples, XORing the parity information may include performing one or more XOR operations, each of which includes comparing two input bits and generating a singular output bit. For example, XORing the parity information may include performing a quantity of XOR operations to compare the parity information associated with page 0 of the logical partition 205-a with the parity information associated with page 0 of the logical partition 205-b, and generating new parity information (e.g., Parity0). Then, the memory system 110 may store the XOR'ed parity information (e.g., Parity0) within a page 0 (e.g., corresponding to page 0 of the logical partition 205-a and page 0 of the logical partition 205-b) of the parity storage 215.

In some cases, the memory system 110 may perform a similar process for generating and storing parity information for each page of the logical partition 205-a and the logical partition 205-b. For example, the memory system 110 may XOR parity information associated with page 1 of the logical partition 205-a with parity information associated with page 1 of the logical partition 205-b, and store the XOR'ed parity information (e.g., Parity1) in a corresponding page 1 of the parity storage 215. In some cases, the memory system 110 may perform a similar process for generating and storing parity information for a plurality of logical partitions 205, such that the parity storage 215 may support storing new parity information resultant from XORing parity information from each logical partition 205 of the memory system 110. For example, the memory system 110 may include 7 logical partitions 205, and may support XORing parity information from a same page of each of the 7 logical partition 205. In some such examples, the memory system 110 may store the XOR'ed parity information in a corresponding page of the parity storage 215.

In some cases, the parity storage 215 may have a storage capacity, such that the parity storage 215 may not have a same quantity of pages as logical partitions 205. For example, the parity storage 215 may include 36 pages, yet each logical partition 205 may have a greater quantity of pages (e.g., 72 pages). In some such cases, the memory system 110 may be configured to support RAIN parity for the additional pages of the logical partition 205 based on regenerating the parity information stored to the parity storage 215. For example, the parity storage 215 may include pages 0-35, however the memory system 110 may write data (e.g., Data36) to page 36 of the logical partition 205-a. In such cases, the memory system 110 may perform one or more logical operations to deconstruct the parity information stored to page 0 of the parity storage 215. In some implementations, deconstructing the parity information may include deXORing (e.g., an inverse of an XOR operation) the parity information to regenerate the parity information associated with the page 0 of the logical partition 205-a and the parity information associated with the page 0 of the logical partition 205-b. Then, the memory system 110 may read the data stored to page 0 of the logical partition 205-a and may use the parity information associated with page 0 of the logical partition 205-a to verify the validity of the data.

In some cases, verifying the validity of the data may include identifying (e.g., determining, detecting) that errors are not present in the data, or the quantity of errors present in the data is less than a threshold quantity of errors. That is, verifying the validity of the data may include identifying (e.g., determining, detecting) a quantity of errors in the data, and comparing the quantity of errors in the data to the threshold quantity of errors. If the quantity of errors in the data satisfies (e.g., is less than) the threshold quantity of errors, the data may be valid data. However, if the quantity of errors in the data fails to satisfy (e.g., is greater than) the threshold quantity of errors, the data may be invalid data. In some cases, the memory system 110 may correct the invalid data based on determining the quantity of errors in the data fails to satisfy the threshold quantity of errors.

Based on verifying the data stored to page 0 of the logical partition 205-a, the memory system 110 may erase the data and/or the parity information associated with page 0 of the logical partition 205-a. For example, the memory system 110 may determine that the data is valid and may erase the data and/or the parity information associated with page 0 of the logical partition 205-a. Conversely, the memory system 110 may determine that the data associated with page 0 of the logical partition 205-a is invalid data, and the memory system 110 may use the corresponding parity information to correct one or more errors in the data such that the quantity of errors in the data satisfies the threshold quantity of errors. The memory system may erase the data and/or the parity information based on correcting the one or more errors.

Then, the memory system 110 may generate the parity information to be stored to page 0 of the parity storage 215 based on XORing the parity information associated with page 36 of the logical partition 205-a with the parity information associated with page 0 of the logical partition 205-b. The memory system 110 may store the new parity information to page 0 of the parity storage 215. In some cases, regenerating the parity information may include XORing the parity information associated with page 36 of the logical partition 205-a with the parity information associated with page 0, page 36, page 72, or so on, from each of the logical partitions 205 of the memory system 110.

A similar method may be applied for performing maintenance operations (e.g., garbage collection) on the memory system 110. That is, after a maintenance operation is initiated, the memory system 110 may deXOR the parity information stored to the parity storage 215. Then, the memory system 110 may consolidate the data of the logical partitions 205, which may include erasing and/or overwriting data stored to the pages of the logical partitions 205. For example, the memory system 110 may erase the data and/or the parity information associated with the data from the logical partition 205-a. Then, the memory system 110 may XOR (e.g., reXOR) the remaining parity information associated with the remaining logical partitions 205, and may store the remaining parity information in the parity storage 215.

In accordance with examples as described herein, storing parity information from each logical partition 205 of the memory system 110 in the parity storage 215 may enable RAIN parity protection without increasing a size of volatile memory associated with storing parity bits. That is, the methods described herein may support RAIN parity protection without increasing expenses associated with implementing RAIN parity protection, among other advantages.

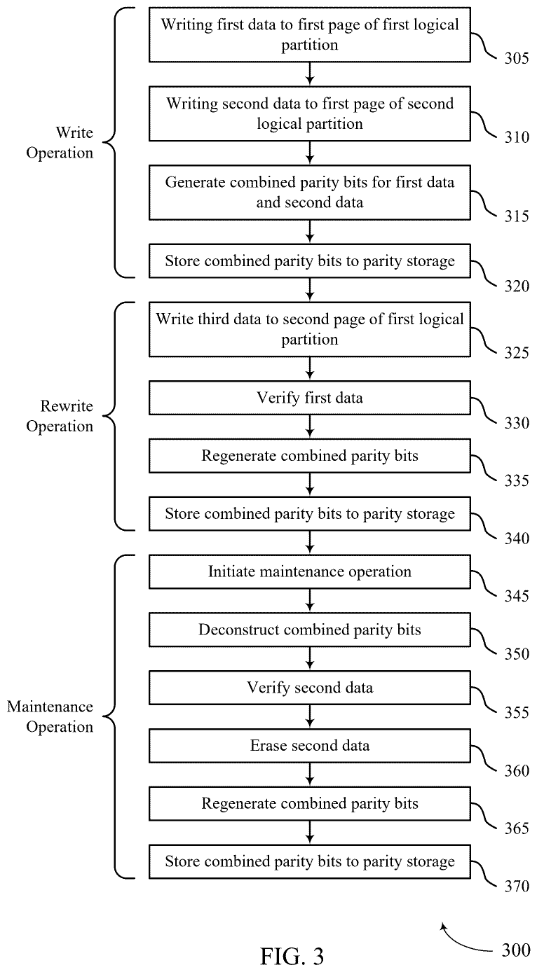

FIG. 3 shows an example of a process flow 300 that supports shared parity storage in accordance with examples as disclosed herein. The process flow 300 may illustrate aspects or operations of a system, which may be an example of a system 100, as described with reference to FIG. 1. For example, the process flow 300 may be implemented by a memory system 110, as described with reference to FIG. 1. In the following description of the process flow 300, the methods, techniques, processes, and operations may be performed in different orders or at different times. Further, some operations may be left out of the process flow 300, or other operations may be added to the process flow 300.

Aspect of the process flow 300 described at the memory system 110 may be implemented by a memory system controller 115 or by a host system 105, as described with reference to FIG. 1. Additionally, or alternatively, aspects of the process flow 300 may be implemented as instructions stored in memory (e.g., firmware). For example, the instructions, if executed by a controller (e.g., a processor, a host system controller, the memory system controller 115, a local controller 135), may cause the controller to perform the operations of the process flow 300. The process flow 300 may support shared parity storage, in which parity information associated with data stored to logical partitions (e.g., logical partitions 205 as described with reference to FIG. 2) of the memory system may be combined and stored to a parity storage (e.g., parity storage 215 as described with reference to FIG. 2). Steps 305 through 320 of the process flow 300 may be associated with a write operation; steps 325 through 340 of the process flow 300 may be associated with a rewrite operation; and steps 345 through 370 may be associated with a maintenance operation.

At 305, first data (e.g., Data0) may be written to a first logical partition (e.g., logical partition 205-a) of the memory system. For example, the first data may be written to a first page (e.g., page 0) of the first logical partition, where the page spans a quantity of planes (e.g., planes 210) of the first logical partition. In some cases, the first data may be received based on receiving a first write command (e.g., from the host system 105). In some cases, writing the first data to the first logical partition may include storing the first data to a cache of the memory system and transferring the first data from the cache to the first page of the first logical partition.

Additionally, at 305, one or more first parity bits associated with the first data may be identified. The one or more first parity bits may be parity information that supports recovery, error detection, or error correction (e.g., or a combination thereof) of the first data. In some cases, the one or more first parity bits may be received based on receiving the first data via the first write command. In other cases, the one or more first parity bits may be generated by the memory system.

At 310, second data (e.g., Data0) may be written to a second logical partition (e.g., logical partition 205-b) of the memory system. For example, the second data may be written to a first page (e.g., page 0) of the second logical partition, where the page spans a quantity of planes (e.g., planes 210) of the second logical partition. The second data may be different than the first data, such that the data bits of the second data may be different than data bits of the first data. In some cases, the second data may be received based on receiving a second write command (e.g., from the host system 105). In some cases, writing the second data to the second logical partition may include storing the second data to the cache and transferring the second data from the cache to the first page of the second logical partition.

Additionally, at 310, one or more second parity bits associated with the second data may be identified. The one or more second parity bits may be parity information that supports recovery, error detection, or error correction (e.g., or a combination thereof) of the second data. The one or more second parity bits may be different than the one or more first parity bits. For example, the one or more second parity bits may be different than the one or more first parity bits based on the data bits of the second data being different than data bits of the first data. In some cases, the one or more second parity bits may be received based on receiving the second data via the second write command. In other cases, the one or more second parity bits may be generated by the memory system.

At 315, one or more logical operations may be performed to generate one or more combined parity bits using the one or more first parity bits and the one or more second parity bits. For example, the memory system may XOR the one or more first parity bits and the one or more second parity bits to generate the one or more combined parity bits. That is, the memory system may perform one or more XOR operations to XOR each of the one or more first parity bits with each of the one or more second parity bits to generate the one or more combined parity bits.

At 320, the one or more combined parity bits may be stored to parity storage (e.g., parity storage 215). For example, the one or more combined parity bits may be stored to a first page of the parity storage based on the one or more first parity bits and the one or more second parity bits being associated with data stored in respective first pages of the first logical partition and the second logical partition.

At 325, third data (e.g., Data1) may be written to the first logical partition. For example, the third data may be written to a second page (e.g., page 36) of the first logical partition. In some cases, the third data may be received based on receiving a third write command (e.g., from the host system 105). In some cases, writing the third data to the first logical partition may include storing the third data to the cache and transferring the third data from the cache to the second page of the first logical partition.

Additionally, at 310, one or more third parity bits associated with the third data may be identified. The one or more third parity bits may be parity information that supports recovery, error detection, or error correction (e.g., or a combination thereof) of the third data. In some cases, the one or more third parity bits may be received based on receiving the third data via the third write command. In other cases, the one or more third parity bits may be generated by the memory system.

At 330, the first data may be verified. The memory system may deconstruct the one or more combined parity bits stored in the parity storage to regenerate the one or more first parity bits and the one or more second parity bits. The memory system may read the first data from the first page of the first logical partition and may use the one or more first parity bits to verify the validity of the first data.

In some cases, the first data may be verified based on identifying (e.g., determining) that the one or more third parity bits correspond to respective bits of the one or more first parity bits. For example, the second page of the first logical partition may correspond to a same position of the parity storage as the first page of the first logical partition. In some cases, verifying the first data may include erasing the first data and/or the one or more first parity bits.

At 335, the one or more combined parity bits may be regenerated using the one or more third parity bits and the one or more second parity bits. That is, the memory system may perform one or more logical operations to regenerate the combined parity bits using the one or more third parity bits and the one or more second parity bits. For example, the memory system may XOR the one or more third parity bits and the one or more second parity bits to generate the one or more combined parity bits. In some cases, the one or more combined parity bits may be regenerated based on verifying the first data.

At 340, the one or more regenerated parity bits may be stored to the parity storage. For example, the one or more combined parity bits may be stored to the first page of the parity storage based on the one or more third parity bits and the one or more second parity bits being associated with data stored in corresponding pages within the first logical partition and the second logical partition, respectively, relative to the parity storage.

At 345, a maintenance operation may be initiated. In some cases, the maintenance operation may be initiated based on receiving a command to perform the maintenance operation (e.g., from the host system 105). In other cases, the maintenance operation may be initiated based on one or more monitored conditions or operating parameters of the memory system. The maintenance operation may be a garbage collection operation where valid data from one logical partition may be folded (e.g., consolidated and transferred) to another logical partition, then the logical partition may be erased.

At 350, the one or more combined parity bits may be deconstructed into the one or more third parity bits and the one or more second parity bits. For example, the memory system may perform one or more deXOR operations, which may be the inverse of the XOR operations, to deconstruct the one or more combined parity bits stored in the parity storage. In some cases, deconstructing the one or more combined parity bits may include deconstructing the parity bits stored in each page of the parity storage.

At 355, the second data may be verified. The memory system may read the second data from the first page of the second logical partition and use the one or more second parity bits to verify the validity of the second data. The second data may be selected during the initiation of the maintenance operation at 345 for folding to another logical partition. In some cases, verifying the second data may include verifying data stored in each page of the second logical partition based on deconstructing the parity bits stored in each page of the parity storage.

In some cases, verifying the second data may include folding the second data to another logical partition based on verifying the validity of the second data. In some such cases, verifying the second data may include folding all the valid data from the second logical partition to another logical partition. For example, the memory system may identify data in a subset of pages of the second logical partition valid, and the memory system may fold the data to another logical partition.

At 360, the second data may be erased. The memory system may erase the second data based on verifying the validity of the second data. In some cases, the second data may be erased based on folding the second data during the verification operation. In some examples, when the memory system identifies that data in the subset of pages of the second logical partition is valid, the memory system may erase the data remaining in the remaining pages of the second logical partition based on folding the data to another logical partition. In some cases, the data in the second logical partition may be erased based on folding valid data from the second logical partition to another logical partition. In some examples, the one or more second parity bits may be erased based on verifying the second data. That is, all the parity bits associated with data from the second logical partition may be erased based on folding the valid data from the second logical partition to another logical partition.

At 365, the one or more combined parity bits may be generated (e.g., regenerated) using the one or more third parity bits and parity bits associated with data from other logical partitions of the memory system. That is, the memory system may perform one or more logical operations to regenerate the combined parity bits using the one or more third parity bits and the parity bits associated with data in a corresponding page of each of the other logical partitions. For example, the memory system may XOR the one or more third parity bits and parity bits associated with data from the first page (e.g., or the 37th page, or the 73rd page, or so on) of the other logical partitions. In some cases, the one or more combined parity bits may be regenerated based on folding the second data. In some cases, regenerating the one or more combined parity bits may include combining parity bits associated with each respective page from each logical partition of the memory system.

At 370, the one or more regenerated parity bits may be stored to the parity storage. For example, the one or more combined parity bits associated with the first page of the parity storage may be stored to the first page of the parity storage. That is, the one or more third parity bits and the other parity bits associated with corresponding first pages of the other logical partitions may be regenerated to form the one or more combined parity bits. Then, the one or more combined parity bits may be stored to the first page of the parity storage. In some cases, storing the combined parity bits may include storing the combined parity bits associated with each page of the memory system 110 in the respective page of the parity storage.

In some cases, the process flow 300 may illustrate examples of operations which may be implemented with different relative quantities. For example, with the write operation, the process flow 300 depicts writing data to two logical partitions, however the process flow 300 should also cover writing data to each logical partition of the memory system. Likewise, the process flow 300 details generating and storing combined parity bits for the first page of the first logical partition and the second logical partition, however the process flow 300 is also representative of generating and storing combined parity bits for each page of the logical partitions. Similar conventions should be acknowledged for the rewrite operation and the maintenance operation.

In accordance with examples as described herein, storing parity information from each logical partition of the memory system in the parity storage may enable RAIN parity protection without increasing a size of volatile memory associated with the parity storage. That is, the process flow 300 described herein may support RAIN parity protection without increasing expenses associated with implementing RAIN parity protection, among other advantages.

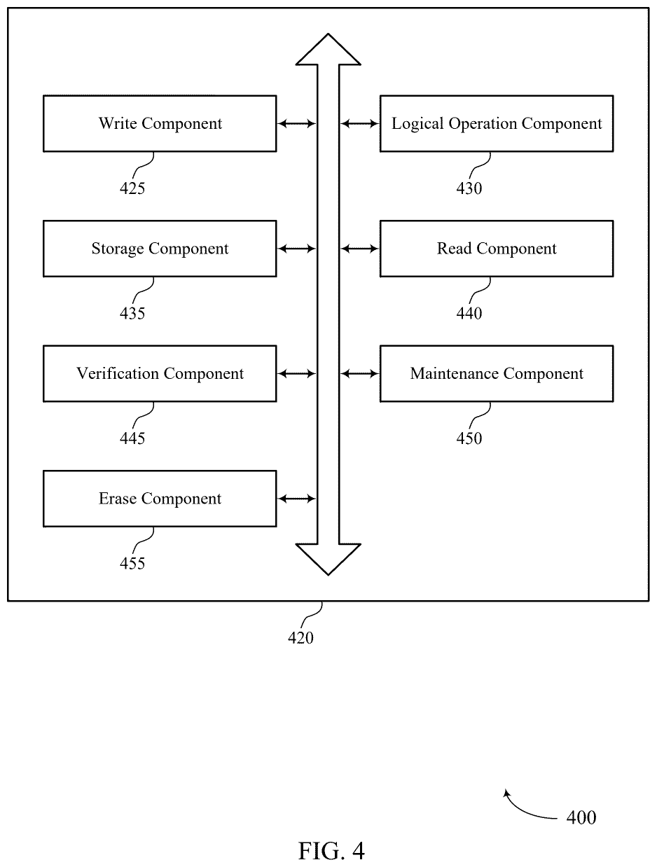

FIG. 4 shows a block diagram 400 of a memory system 420 that supports shared parity storage in accordance with examples as disclosed herein. The memory system 420 may be an example of aspects of a memory system as described with reference to FIGS. 1 through 3. The memory system 420, or various components thereof, may be an example of means for performing various aspects of shared parity storage as described herein. For example, the memory system 420 may include a write component 425, a logical operation component 430, a storage component 435, a read component 440, a verification component 445, a maintenance component 450, an erase component 455, or any combination thereof. Each of these components, or components of subcomponents thereof (e.g., one or more processors, one or more memories), may communicate, directly or indirectly, with one another (e.g., via one or more buses).

The write component 425 may be configured as or otherwise support a means for writing first data to a first page associated with a first logical partition of a memory system, where the first data is associated with a first set of parity bits. In some examples, the write component 425 may be configured as or otherwise support a means for writing second data to a first page associated with a second logical partition of the memory system, where the second data is associated with a second set of parity bits. The logical operation component 430 may be configured as or otherwise support a means for generating a third set of parity bits by performing a first logical operation on the first set of parity bits and the second set of parity bits based at least in part on writing the second data to the first page associated with the second logical partition. The storage component 435 may be configured as or otherwise support a means for storing the third set of parity bits to a volatile memory of the memory system based at least in part on generating the third set of parity bits.

In some examples, the write component 425 may be configured as or otherwise support a means for writing third data to a second page associated with the first logical partition, where the third data is associated with a fourth set of parity bits. In some examples, the logical operation component 430 may be configured as or otherwise support a means for performing a second logical operation on the third set of parity bits based at least in part on writing the third data to the second page associated with the first logical partition. In some examples, the logical operation component 430 may be configured as or otherwise support a means for generating a fifth set of parity bits based at least in part on performing the second logical operation on the third set of parity bits. In some examples, the storage component 435 may be configured as or otherwise support a means for storing the fifth set of parity bits to the volatile memory based at least in part on generating the fifth set of parity bits.

In some examples, performing the second logical operation on the third set of parity bits re-generates the first set of parity bits and the second set of parity bits. In some examples, generating the fifth set of parity bits includes performing the first logical operation on the second set of parity bits and the fourth set of parity bits.

In some examples, the first logical operation includes an exclusive-or (XOR) operation and the second logical operation includes an inverse of an XOR operation.

In some examples, the read component 440 may be configured as or otherwise support a means for reading the first data from the first page based at least in part on writing the third data to the second page. In some examples, the verification component 445 may be configured as or otherwise support a means for performing, based at least in part on reading the first data, a verification operation on the first data using the third set of parity bits, where performing the second logical operation on the third set of parity bits is based at least in part on performing the verification operation.

In some examples, the write component 425 may be configured as or otherwise support a means for writing fourth data to a first page of a third logical partition of the memory system, where the fourth data is associated with a sixth set of parity bits, where the third set of parity bits is generated by performing the first logical operation on the first set of parity bits, the second set of parity bits, and the sixth set of parity bits.

In some examples, the maintenance component 450 may be configured as or otherwise support a means for initiating a maintenance operation on the first logical partition, the second logical partition, and the third logical partition. In some examples, the logical operation component 430 may be configured as or otherwise support a means for performing a second logical operation on the third set of parity bits based at least in part on initiating the maintenance operation, where performing the second logical operation on the third set of parity bits re-generates the first set of parity bits, the second set of parity bits, and the third set of parity bits. In some examples, the verification component 445 may be configured as or otherwise support a means for verifying a validity of the first data using the re-generated first set of parity bits. In some examples, the erase component 455 may be configured as or otherwise support a means for erasing, as part of the maintenance operation, the first data from the first page of the first logical partition based at least in part on verifying the validity of the first data.

In some examples, the logical operation component 430 may be configured as or otherwise support a means for generating a seventh set of parity bits by performing the first logical operation on the second set of parity bits and the sixth set of parity bits based at least in part on erasing the first data from the first page associated with the first logical partition. In some examples, the storage component 435 may be configured as or otherwise support a means for storing the seventh set of parity bits to the volatile memory based at least in part on generating the seventh set of parity bits.

In some examples, to support writing the first data, the storage component 435 may be configured as or otherwise support a means for storing the first data to a cache of the memory system. In some examples, to support writing the first data, the logical operation component 430 may be configured as or otherwise support a means for generating the first set of parity bits. In some examples, to support writing the first data, the write component 425 may be configured as or otherwise support a means for transferring the first data and the first set of parity bits from the cache to the first page associated with the first logical partition, where the third set of parity bits are generated based at least in part on transferring the first data and the first set of parity bits from the cache to the first page associated with the first logical partition.

In some examples, the memory system includes a plurality of logical partitions. In some examples, each logical partition of the plurality of logical partitions includes a super block spanning one or more planes of one or more memory dies of the memory system.

In some examples, each logical partition of the plurality of logical partitions includes a respective set of pages. In some examples, each respective page spans the one or more planes of the one or more memory dies of the memory system.

In some examples, the first page associated with the first logical partition corresponds to the first page associated with the second logical partition.

In some examples, the first page associated with the first logical partition and the first page associated with the second logical partition each include a plurality of single-level memory cells (SLCs), multi-level memory cells (MLCs), triple-level memory cells (TLCs), or quad-level memory cells (QLCs).

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

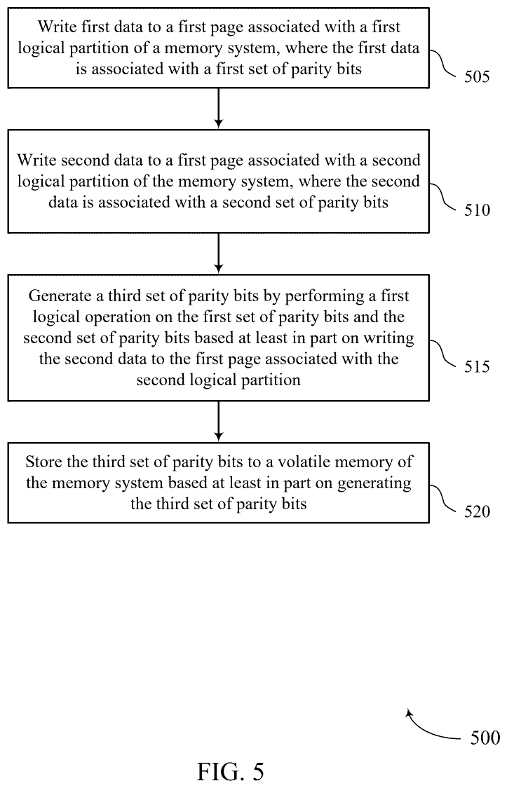

FIG. 5 shows a flowchart illustrating a method 500 that supports shared parity storage in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include writing first data to a first page associated with a first logical partition of a memory system, where the first data is associated with a first set of parity bits. In some examples, aspects of the operations of 505 may be performed by a write component 425 as described with reference to FIG. 4.

At 510, the method may include writing second data to a first page associated with a second logical partition of the memory system, where the second data is associated with a second set of parity bits. In some examples, aspects of the operations of 510 may be performed by a write component 425 as described with reference to FIG. 4.

At 515, the method may include generating a third set of parity bits by performing a first logical operation on the first set of parity bits and the second set of parity bits based at least in part on writing the second data to the first page associated with the second logical partition. In some examples, aspects of the operations of 515 may be performed by a logical operation component 430 as described with reference to FIG. 4.

At 520, the method may include storing the third set of parity bits to a volatile memory of the memory system based at least in part on generating the third set of parity bits. In some examples, aspects of the operations of 520 may be performed by a storage component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for writing first data to a first page associated with a first logical partition of a memory system, where the first data is associated with a first set of parity bits; writing second data to a first page associated with a second logical partition of the memory system, where the second data is associated with a second set of parity bits; generating a third set of parity bits by performing a first logical operation on the first set of parity bits and the second set of parity bits based at least in part on writing the second data to the first page associated with the second logical partition; and storing the third set of parity bits to a volatile memory of the memory system based at least in part on generating the third set of parity bits.

Aspect 2: The method, apparatus, or non-transitory computer-readable medium of aspect 1, further including operations, features, circuitry, logic, means, or instructions, or any combination thereof for writing third data to a second page associated with the first logical partition, where the third data is associated with a fourth set of parity bits; performing a second logical operation on the third set of parity bits based at least in part on writing the third data to the second page associated with the first logical partition; generating a fifth set of parity bits based at least in part on performing the second logical operation on the third set of parity bits; and storing the fifth set of parity bits to the volatile memory based at least in part on generating the fifth set of parity bits.

Aspect 3: The method, apparatus, or non-transitory computer-readable medium of aspect 2, where performing the second logical operation on the third set of parity bits re-generates the first set of parity bits and the second set of parity bits and generating the fifth set of parity bits includes performing the first logical operation on the second set of parity bits and the fourth set of parity bits.

Aspect 4: The method, apparatus, or non-transitory computer-readable medium of any of aspects 2 through 3, where the first logical operation includes an exclusive-or (XOR) operation and the second logical operation includes an inverse of an XOR operation.

Aspect 5: The method, apparatus, or non-transitory computer-readable medium of any of aspects 2 through 4, further including operations, features, circuitry, logic, means, or instructions, or any combination thereof for reading the first data from the first page based at least in part on writing the third data to the second page and performing, based at least in part on reading the first data, a verification operation on the first data using the third set of parity bits, where performing the second logical operation on the third set of parity bits is based at least in part on performing the verification operation.

Aspect 6: The method, apparatus, or non-transitory computer-readable medium of any of aspects 1 through 5, further including operations, features, circuitry, logic, means, or instructions, or any combination thereof for writing fourth data to a first page of a third logical partition of the memory system, where the fourth data is associated with a sixth set of parity bits, where the third set of parity bits is generated by performing the first logical operation on the first set of parity bits, the second set of parity bits, and the sixth set of parity bits.

Aspect 7: The method, apparatus, or non-transitory computer-readable medium of aspect 6, further including operations, features, circuitry, logic, means, or instructions, or any combination thereof for initiating a maintenance operation on the first logical partition, the second logical partition, and the third logical partition; performing a second logical operation on the third set of parity bits based at least in part on initiating the maintenance operation, where performing the second logical operation on the third set of parity bits re-generates the first set of parity bits, the second set of parity bits, and the third set of parity bits; verifying a validity of the first data using the re-generated first set of parity bits; and erasing, as part of the maintenance operation, the first data from the first page of the first logical partition based at least in part on verifying the validity of the first data.

Aspect 8: The method, apparatus, or non-transitory computer-readable medium of aspect 7, further including operations, features, circuitry, logic, means, or instructions, or any combination thereof for generating a seventh set of parity bits by performing the first logical operation on the second set of parity bits and the sixth set of parity bits based at least in part on erasing the first data from the first page associated with the first logical partition and storing the seventh set of parity bits to the volatile memory based at least in part on generating the seventh set of parity bits.

Aspect 9: The method, apparatus, or non-transitory computer-readable medium of any of aspects 1 through 8, where writing the first data includes operations, features, circuitry, logic, means, or instructions, or any combination thereof for storing the first data to a cache of the memory system; generating the first set of parity bits; and transferring the first data and the first set of parity bits from the cache to the first page associated with the first logical partition, where the third set of parity bits are generated based at least in part on transferring the first data and the first set of parity bits from the cache to the first page associated with the first logical partition.

Aspect 10: The method, apparatus, or non-transitory computer-readable medium of any of aspects 1 through 9, where the memory system includes a plurality of logical partitions and each logical partition of the plurality of logical partitions includes a super block spanning one or more planes of one or more memory dies of the memory system.

Aspect 11: The method, apparatus, or non-transitory computer-readable medium of aspect 10, where each logical partition of the plurality of logical partitions includes a respective set of pages and each respective page spans the one or more planes of the one or more memory dies of the memory system.

Aspect 12: The method, apparatus, or non-transitory computer-readable medium of any of aspects 1 through 11, where the first page associated with the first logical partition corresponds to the first page associated with the second logical partition.

Aspect 13: The method, apparatus, or non-transitory computer-readable medium of any of aspects 1 through 12, where the first page associated with the first logical partition and the first page associated with the second logical partition each include a plurality of single-level memory cells (SLCs), multi-level memory cells (MLCs), triple-level memory cells (TLCs), or quad-level memory cells (QLCs).

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples. ” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.” As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
write first data to a first page associated with a first logical partition of the memory system, wherein the first data is associated with a first set of parity bits;
write second data to a first page associated with a second logical partition of the memory system, wherein the second data is associated with a second set of parity bits;
generate a third set of parity bits by performing a first logical operation on the first set of parity bits and the second set of parity bits based at least in part on writing the second data to the first page associated with the second logical partition; and
store the third set of parity bits to a volatile memory of the memory system based at least in part on generating the third set of parity bits.

2. The memory system of claim 1, wherein the processing circuitry is further configured to cause the memory system to:
write third data to a second page associated with the first logical partition, wherein the third data is associated with a fourth set of parity bits;
perform a second logical operation on the third set of parity bits based at least in part on writing the third data to the second page associated with the first logical partition;
generate a fifth set of parity bits based at least in part on performing the second logical operation on the third set of parity bits; and
store the fifth set of parity bits to the volatile memory based at least in part on generating the fifth set of parity bits.

3. The memory system of claim 2, wherein:
performing the second logical operation on the third set of parity bits re-generates the first set of parity bits and the second set of parity bits; and
generating the fifth set of parity bits comprises performing the first logical operation on the second set of parity bits and the fourth set of parity bits.

4. The memory system of claim 2, wherein the first logical operation comprises an exclusive-or (XOR) operation and the second logical operation comprises an inverse of an XOR operation.

5. The memory system of claim 2, wherein the processing circuitry is further configured to cause the memory system to:
read the first data from the first page based at least in part on writing the third data to the second page; and
perform, based at least in part on reading the first data, a verification operation on the first data using the third set of parity bits, wherein performing the second logical operation on the third set of parity bits is based at least in part on performing the verification operation.

6. The memory system of claim 1, wherein the processing circuitry is further configured to cause the memory system to:
write fourth data to a first page of a third logical partition of the memory system, wherein the fourth data is associated with a sixth set of parity bits, wherein the third set of parity bits is generated by performing the first logical operation on the first set of parity bits, the second set of parity bits, and the sixth set of parity bits.

7. The memory system of claim 6, wherein the processing circuitry is further configured to cause the memory system to:
initiate a maintenance operation on the first logical partition, the second logical partition, and the third logical partition;
perform a second logical operation on the third set of parity bits based at least in part on initiating the maintenance operation, wherein performing the second logical operation on the third set of parity bits re-generates the first set of parity bits, the second set of parity bits, and the third set of parity bits;
verify a validity of the first data using the re-generated first set of parity bits; and
erase, as part of the maintenance operation, the first data from the first page of the first logical partition based at least in part on verifying the validity of the first data.

8. The memory system of claim 7, wherein the processing circuitry is further configured to cause the memory system to:
generate a seventh set of parity bits by performing the first logical operation on the second set of parity bits and the sixth set of parity bits based at least in part on erasing the first data from the first page associated with the first logical partition; and
store the seventh set of parity bits to the volatile memory based at least in part on generating the seventh set of parity bits.

9. The memory system of claim 1, wherein writing the first data comprises the processing circuitry configured to cause the memory system to:
store the first data to a cache of the memory system;
generate the first set of parity bits; and
transfer the first data and the first set of parity bits from the cache to the first page associated with the first logical partition, wherein the third set of parity bits are generated based at least in part on transferring the first data and the first set of parity bits from the cache to the first page associated with the first logical partition.

10. The memory system of claim 1, wherein:
the memory system comprises a plurality of logical partitions, each logical partition of the plurality of logical partitions comprises a super block spanning one or more planes of one or more memory dies of the memory system.

11. The memory system of claim 10, wherein:
each logical partition of the plurality of logical partitions comprises a respective set of pages, and
each respective page spans the one or more planes of the one or more memory dies of the memory system.

12. The memory system of claim 1, wherein the first page associated with the first logical partition corresponds to the first page associated with the second logical partition.

13. The memory system of claim 1, wherein the first page associated with the first logical partition and the first page associated with the second logical partition each comprise a plurality of single-level memory cells (SLCs), multi-level memory cells (MLCs), triple-level memory cells (TLCs), or quad-level memory cells (QLCs).

14. A non-transitory computer-readable medium storing code, the code comprising instructions executable by one or more processors to:
write first data to a first page associated with a first logical partition of a memory system, wherein the first data is associated with a first set of parity bits;
write second data to a first page associated with a second logical partition of the memory system, wherein the second data is associated with a second set of parity bits;
generate a third set of parity bits by performing a first logical operation on the first set of parity bits and the second set of parity bits based at least in part on writing the second data to the first page associated with the second logical partition; and
store the third set of parity bits to a volatile memory of the memory system based at least in part on generating the third set of parity bits.

15. The non-transitory computer-readable medium of claim 14, wherein the instructions are further executable by the one or more processors to:
write third data to a second page associated with the first logical partition, wherein the third data is associated with a fourth set of parity bits;
perform a second logical operation on the third set of parity bits based at least in part on writing the third data to the second page associated with the first logical partition;
generate a fifth set of parity bits based at least in part on performing the second logical operation on the third set of parity bits; and
store the fifth set of parity bits to the volatile memory based at least in part on generating the fifth set of parity bits.

16. The non-transitory computer-readable medium of claim 15, wherein:
performing the second logical operation on the third set of parity bits re-generates the first set of parity bits and the second set of parity bits; and
generating the fifth set of parity bits comprises performing the first logical operation on the second set of parity bits and the fourth set of parity bits.

17. The non-transitory computer-readable medium of claim 15, wherein the first logical operation comprises an exclusive-or (XOR) operation and the second logical operation comprises an inverse of an XOR operation.

18. The non-transitory computer-readable medium of claim 15, wherein the instructions are further executable by the one or more processors to:
read the first data from the first page based at least in part on writing the third data to the second page; and
perform, based at least in part on reading the first data, a verification operation on the first data using the third set of parity bits, wherein performing the second logical operation on the third set of parity bits is based at least in part on performing the verification operation.

19. The non-transitory computer-readable medium of claim 14, wherein the instructions are further executable by the one or more processors to:
write fourth data to a first page of a third logical partition of the memory system, wherein the fourth data is associated with a sixth set of parity bits, wherein the third set of parity bits is generated by performing the first logical operation on the first set of parity bits, the second set of parity bits, and the sixth set of parity bits.

20. A method by a memory system, comprising:
writing first data to a first page associated with a first logical partition of the memory system, wherein the first data is associated with a first set of parity bits;
writing second data to a first page associated with a second logical partition of the memory system, wherein the second data is associated with a second set of parity bits;
generating a third set of parity bits by performing a first logical operation on the first set of parity bits and the second set of parity bits based at least in part on writing the second data to the first page associated with the second logical partition; and
storing the third set of parity bits to a volatile memory of the memory system based at least in part on generating the third set of parity bits.

21. The method of claim 20, further comprising:
writing third data to a second page associated with the first logical partition, wherein the third data is associated with a fourth set of parity bits;
performing a second logical operation on the third set of parity bits based at least in part on writing the third data to the second page associated with the first logical partition;
generating a fifth set of parity bits based at least in part on performing the second logical operation on the third set of parity bits; and
storing the fifth set of parity bits to the volatile memory based at least in part on generating the fifth set of parity bits.

22. The method of claim 21, wherein:
performing the second logical operation on the third set of parity bits re-generates the first set of parity bits and the second set of parity bits; and
generating the fifth set of parity bits comprises performing the first logical operation on the second set of parity bits and the fourth set of parity bits.
